(19) United States
(12) Patent Application Publication
(10) Pub. No.: US 2019/0047035 A1
(43) Pub. Date: Feb. 14, 2019

(54) FORMING DIE FOR PRESSURE-FORMING WORKPIECES AND METHOD FOR PRODUCING A FORMING DIE FOR PRESSURE-FORMING WORKPIECES

(71) Applicant: FELLS Systems GmbH, KOENIGSBACH-STEIN (DE)

(72) Inventors: DENNIS BEIHOFER, KAEMPFELBACH (DE); TORBEN LUTHER, FREIBURG (DE); MICHAEL MARRÉ, KARLSRUHE (DE); HENNING WAGNER, REMCHINGEN (DE); WERNER MICHI, OELBRONN-DUERRN (DE)

(73) Assignee: FELLS Systems GmbH, KOENIGSBACH-STEIN (DE)

(21) Appl. No.: 16/048,937

(22) Filed: Jul. 30, 2018

(30) Foreign Application Priority Data
Aug. 9, 2017 (EP) 17185483.9

(51) Int. Cl. B21D 37/10; B29C 70/68

(52) U.S. Cl. CPC B21D 37/10; B29K 2101/12; B29C 70/68

(57) ABSTRACT

A forming die for pressure-forming workpieces comprises a die core and a core reinforcement in the form of a reinforcement member made of fibre-reinforced plastics material. The reinforcement member is radially pretensioned against the die core and comprises a plastics matrix and a reinforcing fibre structure which is embedded in the plastics matrix and which extends in the peripheral direction of the die core. A method for producing the forming die includes applying the the fibre-reinforced plastics material to the die core so as to produce a radial pretensioning of the reinforcement member against the die core.

### CROSS REFERENCE TO RELATED APPLICATIONS

This application claims priority under 35 USC 119 of European Patent Application No. 17185483.9, filed on Aug. 9, 2017 the disclosure of which is herein incorporated by reference.

### BACKGROUND OF THE INVENTION

The invention relates to a forming die for pressure-forming workpieces,
having a die core which has in the interior thereof a workpiece receiving member which extends along a working movement axis of the die core and
having a core reinforcement which surrounds the die core at the outer side thereof in a peripheral direction of the die core around the working movement axis and which is radially pretensioned transversely to the working movement axis against the die core.

The invention further relates to a method for producing a forming die for pressure-forming workpieces, in which a die core of the forming die is provided at the outer side with a core reinforcement in such a manner that the core reinforcement arranged on the die core surrounds the die core in a peripheral direction of the die core around a working movement axis of the die core, along which working movement axis a workpiece receiving member of the die core extends inside the die core, wherein the core reinforcement which is arranged on the die core is radially pretensioned transversely to the working movement axis against the die core.

When workpieces are pressure-formed by means of a forming die, the workpiece which is intended to be formed is arranged in the workpiece receiving member inside a die core. The wall of the workpiece receiving member of the die core is constructed for forming and is to this end provided, for example, with a forming profile. During the forming process, the die core and the workpiece which is arranged inside the workpiece receiving member of the die core are moved relative to each other along a working movement axis of the die core. As a result of the process, the workpiece applies a great radial force to the die core transversely to the working movement axis. In order to prevent undesirable deformation of the die core under the effect of the radial force applied by the workpiece, the die core is radially pretensioned, in the opposite direction to the radial force which is applied by the workpiece, in the direction towards the working movement axis. In order to increase the load-bearing capacity thereof, the die core is provided with a reinforcement which surrounds the die core at the outer side thereof in a peripheral direction around the working movement axis.

Prior art of the generic type is disclosed in WO99/39848 A1. In the case of the prior art, a die core is arranged inside a tension ring which is coaxial with respect to the die core. The tension ring is in turn surrounded in a peripheral direction by an annular band reinforcement which is coaxial with respect to the tension ring and the die core and which is made of steel. The band reinforcement is radially pretensioned transversely to the working movement axis of the die core against the tension ring and, via the tension ring, also against the die core.

In order to receive great radial forces, forming dies of the previously known type have to be provided with a reinforcement of great dimensions and mass. In a forming machine, such forming dies require a large installation space and the handling thereof is made more difficult by the great mass thereof.

### SUMMARY OF THE INVENTION

An object of the present invention is to provide a forming die for pressure-forming workpieces which forming die is small and lightweight but, irrespective thereof, capable of bearing even great loads.

This object is achieved according to the invention by a forming die having a die core which has in the interior thereof a workpiece receiving member which extends along a working movement axis of the die core and having a core reinforcement which surrounds the die core at the outer side.

For the die core of the forming die according to the invention, there is provided a core reinforcement which has a reinforcement member which is radially pretensioned against the die core and which is made of fibre-reinforced plastics material. The reinforcement member comprises a plastics matrix and a reinforcing fibre structure which is embedded in the plastics matrix and which extends in the peripheral direction of the die core about the working movement axis thereof. In the context of the production method according to the invention, a reinforcement member of fibre-reinforced plastics material is applied to the outer side of the die core of the forming die as a core reinforcement so as to produce a radial pretensioning of the reinforcement member against the die core.

The reinforcing fibre structure of the reinforcement member according to the invention can have short, long or endless fibres. In particular, a polymer matrix comprising duromers or thermoplastics is considered as the plastics matrix of the reinforcement member according to the invention.

The reinforcement member made of fibre-reinforced plastics material is distinguished by a great load-bearing capacity with at the same time a small volume and small mass. As a result of the small construction size, the forming die according to the invention can be received in a space-saving manner in a forming machine. The reduced mass of the forming die according to the invention is, for example, significantly advantageous during the handling thereof in the context of changing a tool. Furthermore, forming dies according to the invention are cheaper than conventional forming dies for pressure-forming workpieces.

In a preferred embodiment of the production method according to the invention, the reinforcement member made of fibre-reinforced plastics material is applied directly to the die core. Consequently, a particularly compact unit comprising the die core and the reinforcement member is produced as the forming die.

In another embodiment, in order to produce a reinforcement member which is radially pretensioned against the die core, fibre-reinforced plastics material is applied to the outer side of the die core in the non-hardened state, wherein the die core has at the time of the application of the fibre-reinforced plastics material an assembly core cross-section which is smaller than a core cross-section for use present in a state for use of the die core. After the fibre-reinforced plastics material which has been applied in the wet state has hardened, the cross-section of the die core decreased for the assembly is increased to the cross-section which the die core has during workpiece forming operations. The production of a radial pretensioning of the hardened reinforcement member against the die core is connected with the increase of the die core cross-section which is brought about after the reinforcement member has hardened.

Alternatively, in the context of the production method according to the invention, the reinforcement member is present as a hardened hollow member before application to the die core. In the interior thereof, the hardened reinforcement member has a core receiving member for the die core of the forming die according to the invention. A core receiving member axis of the reinforcement member extends inside the reinforcement member along the working movement axis of the die core in the mounting position. The core receiving member of the reinforcement member has along the core receiving member axis a core receiving member opening at least at one side. In an initial assembly state of the reinforcement member, the core receiving member thereof has an initial core receiving member cross-section. In order to produce readiness for assembly of the reinforcement member and the die core, the core receiving member cross-section of the reinforcement member is increased with respect to the initial core receiving member cross-section and/or the core cross-section of the die core is decreased with respect to the core cross-section for use. It is thereby possible for the core receiving member cross-section of the ready-for-assembly reinforcement member to have such dimensions that the core cross-section of the ready-for-assembly die core is, in the perpendicular projection onto the core receiving member cross-section, within the core receiving member cross-section and consequently the die core for applying the reinforcement member can be introduced into the core receiving member of the reinforcement member. After the production of the readiness for assembly of the reinforcement member and the die core, the ready-for-assembly reinforcement member and the ready-for-assembly die core are accordingly joined. In this case, the reinforcement member and the die core are moved relative to each other along the core receiving member axis of the reinforcement member or along the working movement axis of the die core. If the reinforcement member is arranged at the outer side of the die core in the desired position after the joining operation, the core receiving member cross-section of the reinforcement member is decreased and/or the core cross-section of the die core is increased as a final step. A radial pretensioning of the reinforcement member against the die core is thereby produced.

Unlike the wet winding method described above, it is further possible, in order to produce the reinforcement member, to wind a reinforcing fibre structure comprising dry fibres, preferably comprising dry endless fibres, around the die core with pretensioning. In this case, a durable connection of the reinforcing fibre structure to the die core must be ensured in a separate method step, for example, by adhesive bonding.

In the context of the production methods according to the invention, there is required a decrease of the core cross-section of the die core with respect to the core cross-section for use. In an advantageous embodiment of the production method according to the invention, for this purpose the die core is extended along the working movement axis of the die core with respect to the state for use thereof, preferably resiliently extended and/or the temperature of the die core is changed with respect to the temperature in the state for use of the die core, wherein the temperature of the die core is reduced in case of a corresponding temperature behaviour of the material of the die core.

In order to increase the core receiving member cross-section of the reinforcement member with respect to the initial core receiving member cross-section in the context of the production method according to the invention according to the invention, in another advantageous embodiment, the temperature of the reinforcement member, which is in the form of a hardened hollow member, is changed with respect to the temperature in the initial assembly state of the reinforcement member, wherein the temperature of the reinforcement member is increased or decreased depending on the temperature behaviour of the reinforcement member.

In the context of the production method according to the invention, different types of fibre-reinforced plastics materials can be used for the reinforcement member of the forming die according to the invention. In one production method according to the invention, a reinforcement member which is made of carbon-fibre-reinforced (CFRP) plastics material is applied to the die core so as to produce a radial pretensioning of the reinforcement member against the die core. Carbon-fibre-reinforced plastics materials are distinguished by a particularly high tensile strength combined with a low density. The reinforcing fibre structure of a reinforcement member applied to the die core, which reinforcing fibre structure extends in the peripheral direction of the die core and is made of carbon-fibre-reinforced plastics material, allows, with a particularly lightweight construction, a particularly effective pretensioning of the reinforcement member against the die core of the forming die according to the invention.

If, in the context of the production method according to the invention, a reinforcement member made of carbon-fibre-reinforced plastics material (negative thermal expansion coefficient) and a die core made of a material having a positive thermal expansion coefficient, for example, steel, are joined and if the temperatures of the reinforcement member and the die core are changed in order to produce the readiness for assembly of the reinforcement member and the die core and/or to produce the radial pretensioning of the reinforcement member against the die core, a temperature change of the two components of the forming die according to the invention in the same direction can be carried out. As a result of the temperature behaviour of the materials of the reinforcement member and the die core, the temperatures of both must be decreased in order to produce the readiness for assembly and must be increased in order to produce the radial pretensioning of the reinforcement member against the die core.

### BRIEF DESCRIPTION OF THE DRAWINGS

The invention is explained in greater detail below with reference to exemplary schematic illustrations. In the drawings:

FIGS. 1a, 1b are cross-sections of a forming die for pressure-forming workpieces, having a die core and a core reinforcement,

FIG. 2 shows the sequence of a first variant of a method for producing the forming die according to FIGS. 1a, 1b and

FIG. 3 shows the sequence of a second variant of the method for producing the forming die according to FIGS. 1a, 1b.

### DETAILED DESCRIPTION OF THE EMBODIMENTS

According to FIGS 1a, 1b, a forming die 1 for pressure-forming, in this case for axially forming, workpieces comprises a die core 2 of steel and a reinforcement member 3 made of carbon-fibre-reinforced plastics material. The die core 2 is constructed in a hollow-cylindrical manner and has in the interior thereof a workpiece receiving member 4. The workpiece receiving member 4 extends along a working movement axis 5 of the die core 2 which forms the axis of symmetry of the die core 2. An inner wall 6 of the die core 2, which inner wall 6 extends parallel to the working movement axis 5 and which delimits the workpiece receiving member 4, is provided in conventional manner with a forming profile which is not shown in FIGS. 1a, 1b. An outer wall of the die core 2, which outer wall also extends parallel to the working movement axis 5, delimits a core cross-section QM of the die core 2.

In order to pressure-form workpieces, for example tubes, by means of the forming die 1, the workpiece arranged inside the workpiece receiving member 4 and the forming die 1 are moved relative to each other, as usual, along the working movement axis 5. In this instance, the workpiece is strained beyond the yield point by the forming profile of the die core 2 and is thereby formed.

As a result of the process, the workpiece applies a great radial force to the die core 2 during the forming operation. The effective direction of the radial force applied by the workpiece to the die core 2 is illustrated in FIGS. 1a, 1b by arrows.

So that the die core 2 is not deformed in an undesirable manner under the action of the radial force applied by the workpiece and to increase the load-bearing capacity of the die core 2, the reinforcement member 3 is provided. The reinforcement member 3 is constructed in the example illustrated in the manner of a CFRP pipe with a wound endless fibre structure.

The die core 2 is arranged in a core receiving member 7 of the reinforcement member 3. A core receiving member axis 8 of the reinforcement member 3 coincides with the working movement axis 5 of the die core 2 in the installation position in the core receiving member 7 of the reinforcement member 3. An axially parallel inner wall of the core receiving member 7 delimits a core receiving member cross-section QA of the reinforcement member 3.

In FIGS 1a, 1b, the forming die 1 and, thus, the die core 2 and the reinforcement member 3 are in the state for use in which a forming operation can be carried out by means of the forming die 1. The reinforcement member 3 is radially pretensioned against the die core 2 counter to the direction of the radial force applied by the workpiece to the die core 2 during the forming operation. The die core 2 has a core cross-section for use, the core receiving member 7 of the reinforcement member 3 has a core receiving member cross-section for use.

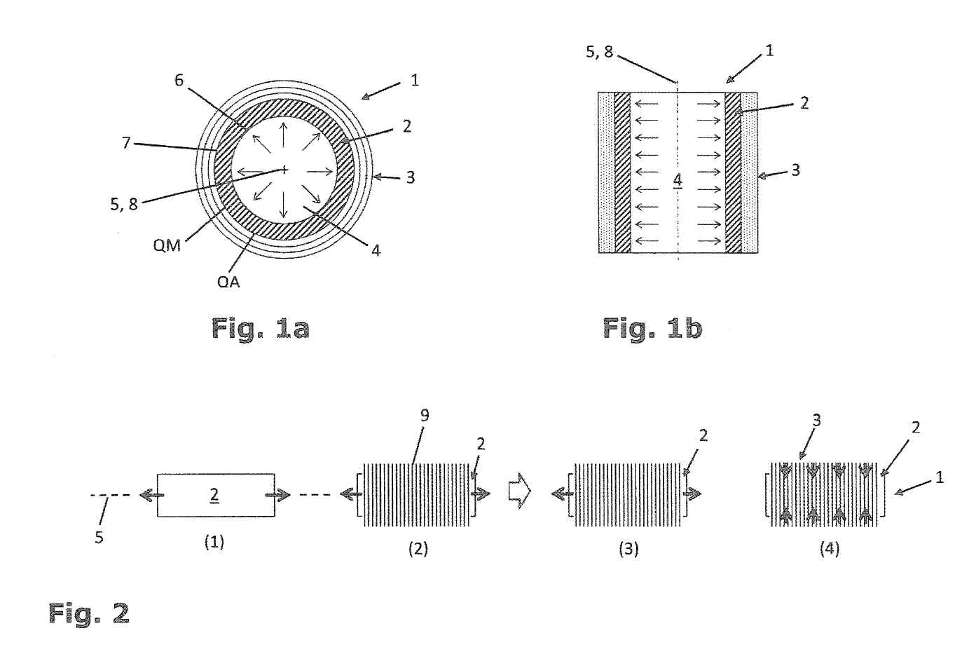

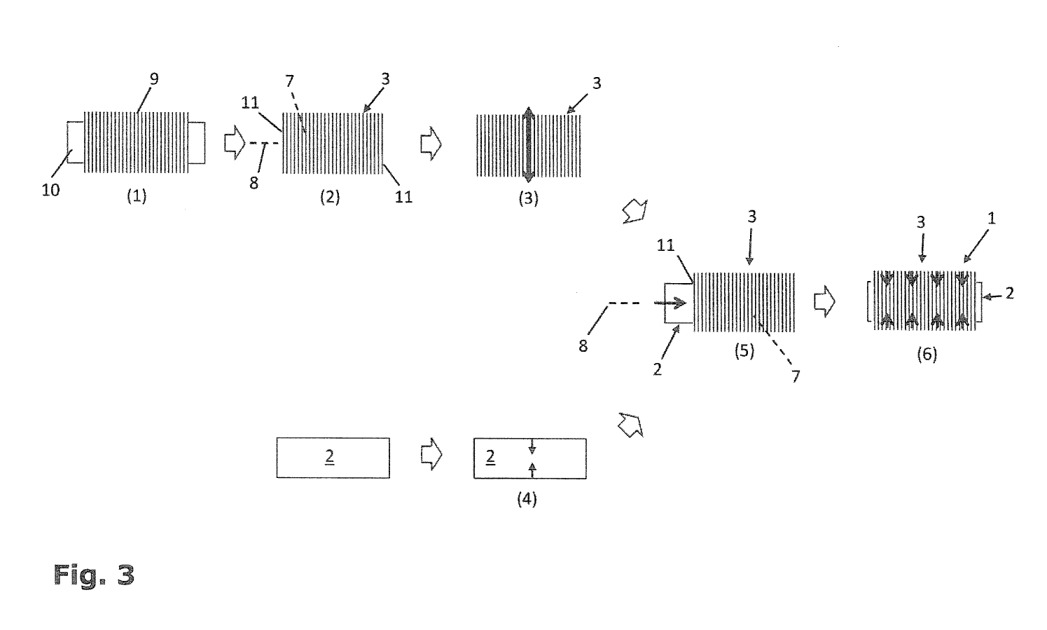

Two possible methods for producing the forming die 1 are illustrated in FIGS. 2 and 3.

According to FIG. 2, in order to produce the forming die 1 initially the die core 2 is resiliently extended along the working movement axis 5 (method step (1) in FIG. 2). The die core 2 is thereby provided with, as a core cross-section QM, an assembly core cross-section which is smaller than the core cross-section for use.

Subsequently, fibre-reinforced plastics material in the wet state is applied to the outer side of the die core 2, which has a decreased cross-section, in such a manner that a reinforcing fibre structure 9 (which is illustrated in a highly schematic manner in FIG. 2) of the fibre-reinforced plastics material with endless carbon fibres extends in the peripheral direction of the die core 2 about the working movement axis 5 (method step (2) in FIG. 2). In the embodiment illustrated, the reinforcement fibre structure 9 with endless carbon fibres is embedded in a thermoplastic matrix (for example, polysulfone/PSU) of the fibre-reinforced plastics material.

With the die core 2 still having a decreased cross-section, the initially wet fibre-reinforced plastics material is tempered and thereby hardened (method step (3) in FIG. 2). After the fibre-reinforced plastics material has hardened, the extension of the die core 2 is ended (method step (4) in FIG. 2). Consequently, the core cross-section QM of the die core 2 increases to the core cross-section for use. There is thereby produced a radial pretensioning (arrows in the part-illustration (4) of FIG. 2) of the reinforcement member 3, produced by hardening the fibre-reinforced plastics material, against the die core 2. Now, the production of the forming die 1 is finished.

Unlike the variant illustrated in FIG. 2 of the method for producing the forming die 1, in the case of the production method according to FIG. 3 the reinforcement member 3 is produced before application to the die core 2 separated therefrom. For this purpose, fibre-reinforced plastics material in the wet state is applied to a mandrel 10 remote from the die core 2 in such a manner that the reinforcing fibre structure 9 of the fibre-reinforced plastics material extends in a peripheral direction of the mandrel 10 around it (method step (1) in FIG. 3). By tempering the initially wet fibre-reinforced plastics material, it is hardened so as to form the reinforcement member 3. The hardened reinforcement member 3 is removed from the mandrel 10 (method step (2) in FIG. 3). There is obtained inside the hardened reinforcement member 3, at the location where the mandrel 10 was previously arranged, the core receiving member 7 which has a core receiving member opening 1 at both sides along the core receiving member axis 8. The core receiving member 7 of the reinforcement member 3 has in this phase of the illustrated production method an initial core receiving member cross-section as the core receiving member cross-section QA.

After the reinforcement member 3 has been provided as a hardened hollow member, the temperature of the reinforcement member 3 is changed, in the embodiment illustrated the reinforcement member 3 is cooled. As a result of the corresponding temperature behaviour of the carbon-fibre-reinforced plastics material used in this case, the cooling results in a widening of the reinforcement member 3 and in connection therewith an increase of the core receiving member cross-section QA of the reinforcement member 3 with respect to the initial core receiving member cross-section (working step (3) in FIG. 3). As a result, the reinforcement member 3 is ready for assembly.

In order to produce the readiness for assembly of the die core 2, the die core 2 is cooled starting from the state for use thereof. The core cross-section QM of the die core 2 is thereby decreased with respect to the core cross-section for use (working step (4) in FIG. 3). As a result, the die core 2 is also ready for assembly.

The core cross-section QM of the ready-for-assembly die core 2 is smaller than the core receiving member cross-section QA of the ready-for assembly reinforcement member 2, wherein the core cross-section QM of the ready-for-assembly die core 2, in the perpendicular projection onto the core receiving member cross-section QA of the ready-for-assembly reinforcement member 3, is within the core receiving member cross-section QA of the ready-for-assembly reinforcement member 3.

After the production of the readiness for assembly of the reinforcement member 3 and the die core 2, the reinforcement member 3 and the die core 2 are joined by the ready-for-assembly die core 2 being pushed along the core receiving member axis 8 into the core receiving member 7 of the reinforcement member 3 through one of the core receiving member openings 11 of the reinforcement member 3 (working step (5) in FIG. 3).

After the die core 2 has taken up the desired position thereof inside the reinforcement member 3, the unit comprising the reinforcement member 3 and the die core 2 is heated (working step (6) in FIG. 3). As a result of the heating, the core cross-section QM of the die core 2 increases while the core receiving member cross-section QA of the reinforcement member 3 is decreased. Due to the increase of the core cross-section QM of the die core 2 with simultaneous decrease of the core receiving member cross-section QA of the reinforcement member 3, the reinforcement member 3 is radially pretensioned against the die core 2. The production of the forming die 1 is complete.

What is claimed is:

1. A forming die for pressure-forming workpieces, comprising:
a die core having a workpiece receiving member in an interior of the die core, the workpiece receiving member extending along a working movement axis of the die core, and
a core reinforcement formed by a reinforcement member which surrounds the die core at an outer side thereof in a peripheral direction of the die core around the working movement axis and which is radially pretensioned transversely to the working movement axis against the die core,
wherein the reinforcement member is made of a fibre-reinforced plastics material comprising a plastics matrix and a reinforcing fibre structure which is embedded in the plastics matrix and which extends in the peripheral direction of the die core.

2. A method for producing a forming die for pressure-forming workpieces, comprising providing an outer side of a die core of the forming die with a core reinforcement formed by a reinforcement member of fibre-reinforced plastics material in such a manner
that the core reinforcement member surrounds the die core in a peripheral direction of the die core around a working movement axis of the die core, along which working movement axis a workpiece receiving member of the die core extends inside the die core, and
that the core reinforcement member is radially pretensioned transversely to the working movement axis against the die core,
wherein the reinforcement member comprises a plastics matrix and a reinforcing fibre structure which is embedded in the plastics matrix and which extends in the peripheral direction of the die core.

3. The method according to claim 2, wherein the reinforcement member made of fibre-reinforced plastics material is applied directly to the die core so as to produce a radial pretensioning of the reinforcement member against the die core.

4. The method according to claim 2, wherein the reinforcement member made of fibre-reinforced plastics material is applied to the die core so as to produce a radial pretensioning of the reinforcement member against the die core by the following steps:
decreasing a core cross-section (QM) of the die core which extends perpendicularly to the working movement axis to an assembly core cross-section which is smaller than a core cross-section for use which is present in a state of use of the die core,
applying the fibre-reinforced plastics material in a non-hardened state to the outer side of the die core in such a manner that the reinforcing fibre structure of the fibre-reinforced plastics material extends in the peripheral direction of the die core, the die core having the assembly core cross-section,
hardening the fibre-reinforced plastics material that has been applied to the outer side of the die core, and
increasing the core cross-section (QM) of the die core to the core cross-section for use after the step of hardening the fibre-reinforced plastics material applied to the outer side of the die core.

5. The method according to claim 2, wherein the reinforcement member made of fibre-reinforced plastics material is applied to the die core so as to produce a radial pretensioning of the reinforcement member against the die core by the following steps:
producing the reinforcement member as a hardened hollow member which has in an interior thereof a core receiving member for the die core, wherein the core receiving member of the reinforcement member has a core receiving member axis which extends along the working movement axis of the die core when the die core is in a mounting position, wherein the core receiving member of the reinforcement member has along the core receiving member axis a core receiving member opening at least at one side and wherein, in an initial assembly state of the reinforcement member, the core receiving member of the reinforcement member has an initial core receiving member cross-section which extends perpendicularly to the core receiving member axis,
providing a ready-for-assembly state of the reinforcement member and a ready-for assembly state of the die core by increasing the core-receiving member cross-section (QA) of the reinforcement member with respect to the initial core receiving member cross-section and/or decreasing a core cross-section (QM) of the die core with respect to a core cross-section for use which is present in a state of use of the die core, wherein the core receiving member cross-section (QA) of the ready-for-assembly reinforcement member is dimensioned so that the core cross-section (QM) of the ready-for-assembly die core is, in a perpendicular projection onto the core receiving member cross-section (QA), within the core receiving member cross-section (QA),
joining the ready-for-assembly reinforcement member and the ready-for-assembly die core, by introducing the ready-for assembly die core through the core receiving member opening of the ready-for-assembly reinforcement member along the core receiving member axis into the core receiving member of the ready-for-assembly reinforcement member so that the reinforcement member is arranged at an outer side of the die core, and
after the reinforcement member and die core have been joined, decreasing the core receiving member cross-section (QA) of the reinforcement member so as to produce the radial pretensioning of the reinforcement member against the die core and/or increasing the core cross-section (QM) of the die core so as to produce the radial pretensioning of the reinforcement member against the die core.

6. The method according to claim 4, wherein the step of decreasing the core cross-section (QM) of the die core is accomplished by extending the die along the working movement axis of the die core.

7. The method according to claim 4, wherein the step of decreasing the core cross-section (QM) of the die core is accomplished by changing a temperature of the die core with respect to a temperature in the state of use of the die core.

8. The method according to claim 5, wherein the step of increasing the core receiving member cross-section (QA) of the reinforcement member is accomplished by changing a temperature of the reinforcement member with respect to a temperature in the initial assembly state of the reinforcement member.

9. The method according to claim 2, wherein the reinforcement member is made of carbon-fibre-reinforced plastics material and the reinforcement member made of carbon-fibre-reinforced plastics material is provided to the die core by applying the reinforcement member made of carbon-fibre-reinforced plastics material to the die core so as to produce a radial pretensioning of the reinforcement member made of carbon-fibre-reinforced plastics material against the die core.

10. The method according to claim 6, wherein the step of decreasing the core cross-section (QM) of the die core is accomplished by resiliently extending the die along the working movement axis of the die core.
